(19) United States
(12) Patent Application Publication
(10) Pub. No.: US 2026/0050363 A1
(43) Pub. Date: Feb. 19, 2026

(54) METHOD, APPARATUS, DEVICE, STORAGE MEDIUM AND PROGRAM PRODUCT FOR MESSAGE NOTIFICATION

(71) Applicant: Beijing Zitiao Network Technology Co., Ltd., Beijing (CN)

(72) Inventors: Wenfeng LIU, Beijing (CN); Longteng PENG, Beijing (CN); Weizhi YAN, Beijing (CN)

(21) Appl. No.: 18/989,558

(22) Filed: Dec. 20, 2024

(30) Foreign Application Priority Data
Aug. 16, 2024 (CN) 202411132172.4

(51) Int. Cl. G06F 3/0484; H04L 51/21

(52) U.S. Cl. CPC G06F 3/0484; H04L 51/21

(57) ABSTRACT

Example methods, devices, and storage media for message notification are provided. In one example method, at least one notification for a first user is acquired, and the at least one notification is generated respectively in response to an interactive behavior that is associated with the first user and that is performed by at least one second user. Association information between the first user and the at least one second user is determined, and notification message content for the first user is generated based at least on the association information and the at least one notification. The notification message content is provided to the first user.

### CROSS-REFERENCE

This application claims the benefit of Chinese Patent Application No. 202411132172.4, filed on Aug. 16, 2024, and entitled “METHOD, APPARATUS, DEVICE, STORAGE MEDIUM AND PROGRAM PRODUCT FOR MESSAGE NOTIFICATION”, which is hereby incorporated by reference in its entirety.

### TECHNICAL FIELD

Example embodiments of the present disclosure generally relate to the field of computers, and more particularly, to a method, apparatus, electronic device, computer readable storage medium, and computer program product for message notification.

### BACKGROUND

With the development of information technology, various terminal devices can provide various services for people in aspects of work, life, and the like. For example, an application providing a service may be deployed in a terminal device, and the terminal device or the application may provide a digital assistant type function for a user, so as to assist the user in using the terminal device or the application. In various applications, various interactive notifications may be received and provided, so as to notify the user of various interactive behaviors that occur with respect to the user.

### SUMMARY

In a first aspect of the present disclosure, a method for message notification is provided. The method including: acquiring at least one notification for a first user, the at least one notification being generated respectively in response to: an interactive behavior associated with the first user and performed by at least one second user; determining association information between the first user and the at least one second user; generating notification message content for the first user based at least on the association information and the at least one notification; and providing the notification message content to the first user.

In a second aspect of the present disclosure, an apparatus for message notification is provided, the apparatus including: a notification acquiring module configured to acquire at least one notification for a first user, the at least one notification being generated respectively in response to: an interactive behavior associated with the first user and performed by at least one second user; an information determining module configured to determine association information between the first user and the at least one second user; a content generating module configured to generate notification message content for the first user based at least on the association information and the at least one notification; and a content providing module configured to provide the notification message content to the first user.

In a third aspect of the present disclosure, an electronic device is provided. The electronic device includes at least one processing unit and at least one memory. The at least one memory is coupled to the at least one processing unit and stores instructions for execution by the at least one processing unit. The instructions, when executed by the at least one processing unit, cause the electronic device to perform the method according to the first aspect of the present disclosure.

In a fourth aspect of the present disclosure, a computer readable storage medium is provided. The computer readable storage medium has a computer program stored thereon, the computer program, when executed by a processor, causes the processor to perform the method according to the first aspect of the present disclosure.

In a fifth aspect of the disclosure, a computer program product. The computer program product is tangibly stored in a computer storage medium and including computer-executable instructions that, when executed by an apparatus, cause the apparatus to perform the method of the first aspect.

It should be appreciated that the content described in this section is not intended to limit critical features or essential features of the embodiments of the disclosure, nor is it intended to limit the scope of the present disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference signs denote the same or similar elements, where:

FIG. 1 illustrates a schematic diagram of an example environment in which embodiments of the present disclosure can be implemented;

FIG. 2 illustrates a flowchart of a process for message notification according to some embodiments of the disclosure;

FIG. 3 illustrates a schematic diagram of a signaling flow for message notification according to some embodiments of the disclosure;

FIG. 4 illustrates a schematic diagram of a signaling flow for message notification according to some other embodiments of the present disclosure;

FIG. 5 illustrates a schematic diagram of a signaling flow for message notification according to yet other embodiments of the present disclosure;

FIG. 6 illustrates an example block diagram of an apparatus for message notification according to some embodiments of the disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below.

Herein, unless explicitly stated otherwise, “performing a step in response to A” does not mean that the step is performed immediately after “A”, but one or more intermediate steps may be included.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the related user shall be informed of the type, usage ranges, usage scenarios, and the like of the personal information involved in this disclosure in an appropriate manner and the user's authorization shall be obtained, in accordance with relevant laws and regulations. The related users may include any type of right bodies, such as individuals, enterprises, and groups.

For example, in response to receiving an active request from a user, prompt information is sent to the related user to explicitly prompt the related user that an operation requested by the user will require obtaining and use of personal information of the related user. Thus, the related user can autonomously select, according to the prompt information, whether to provide information to software or hardware such as an electronic device, an application program, a server, or a storage medium that executes the operations of the technical solutions of the present disclosure.

As an optional but non-limiting implementation, in response to receiving an active request from the related user, prompt information is sent to the related user, for example, in the form of a pop-up window, and the pop-up window may present the prompt information in the form of text. In addition, the pop-up window may also carry a selection control for the user to select whether he/she “agrees”or “disagrees”to provide information to the electronic device.

It can be understood that the above notification and user authorization process are only illustrative, which do not limit the implementation of this disclosure. Other methods that meet relevant laws and regulations can also be applied to the implementation of this disclosure.

As used herein, the term “model” may learn association between corresponding input and output from training data, so that after the training is complete, corresponding output may be generated for given input. The generation of the model may be based on a machine learning technology. Depth learning is a machine learning algorithm that processes input and provides corresponding output by using a multi-tiered processing unit. A neural network model is one example of a model based on deep learning. As used herein, “model” may also be referred to as “machine learning model”, “learning model”, “machine learning network”, or “learning network,” which are used interchangeably herein.

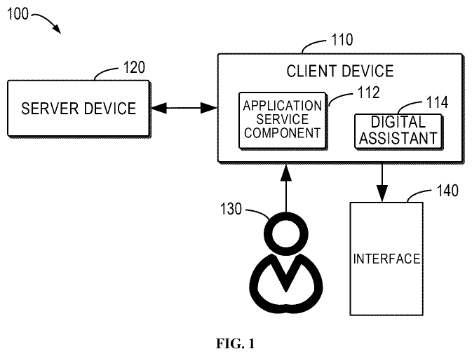

FIG. 1 illustrates a schematic diagram of an example environment 100 in which embodiments of the present disclosure can be implemented. In this example environment 100, an application service component 112 and a digital assistant 114 are installed in a client device 110. A user 130 may interact with the application service component 112 and the digital assistant 114 via the client device 110 and/or an attached device of the client device 110.

In some embodiments, the application service component 112 and the digital assistant 114 may be downloaded, installed on the client device 110. In some embodiments, the application service component 112 and the digital assistant 114 may also be accessed in other ways, such as through a web page, etc. In some embodiments, in the environment 100 of FIG. 1, in response to the application service component 112 being started, the client device 110 can present an interface 140 of the application service component 112 and the digital assistant 114. The interface 140 may be, for example, an interactive interface of the application service component 112 and the digital assistant 114.

The application service component 112 includes, but is not limited to, one or more of a chat application component (also referred to as an instant messaging application component), a document application component, an audio-video conference application component, a mail application component, a task application component, a calendar application component, an objective and key result (OKR) application component, and the like. It will be appreciated that although a single application service component is shown in FIG. 1, a plurality of application service components may be installed on the client device 110. In some embodiments, the application service component 112 may include a multifunctional collaborative platform. For example, an office collaborative platform (also referred to as an office suite) can provide integration of multiple types of service components, so as to facilitate people's activities such as work and communication. In a multifunctional cooperative platform, people can start different service components according to needs to complete corresponding information processing, sharing, communication, etc.

In some embodiments, the digital assistant 114 may be provided by a separate application service component, or may be integrated within some application service component 120 that is capable of providing a content entity. An application service component for providing a client interface for a digital assistant may correspond to a single-function application service component or a multi-function collaboration platform, such as an office suite or other collaboration platform capable of integrating multiple components. It can be understood that, similar to the application service component, although a single digital assistant is shown in FIG. 1, in practice, there may be a plurality of digital assistants.

In some embodiments, the digital assistant 114 supports the use of one or more plug-ins. Each plug-in is capable of providing one or more functions of an application. Such plug-ins include, but are not limited to, one or more of a search plug-in, a contact plug-in, a message plug-in, a document plug-in, a form plug-in, a mail plug-in, a calendar plug-in, a schedule plug-in, a task plug-in, and the like. Customization of various plug-ins can be supported to configure the corresponding functions that can be implemented in the plug-ins. The digital assistant 114 can be configured to be associated with one or more of the default plug-in and/or customized plug-ins.

The digital assistant 114 is a user's intelligent assistant, and has an intelligent conversation and information processing capability. In the embodiments of the present disclosure, the digital assistant 114 is configured for interacting with a user 130, so as to assist the user 130 in using a terminal device or an application. In some embodiments, an interactive window with the digital assistant 114 may be presented in the interface 140. In the interactive window, the user 130 may have a dialog with the digital assistant 114 by inputting a natural language, a picture, an audio file, a video file, a webpage file, and the like, so as to instruct the digital assistant to assist in completing various tasks, including operations on the content entity 126.

In some embodiments, multiple interaction modes may be provided between the user 130 and the digital assistant 114, and switching between the multiple interaction modes may be performed flexibly. In a case that a certain interaction mode is triggered, a corresponding interaction area is presented to facilitate interaction between the user 130 and the digital assistant 114. In different interaction modes, the interaction manners between the user 130 and the digital assistant 114 are different, so that interaction requirements in different application scenarios can be flexibly adapted to.

In some embodiments, the information processing service specific to the user 130 can be provided based on historical interaction information of the user 130 with the digital assistant 114 and/or data range specific to the user 130. In some embodiments, historical interactive information of the user 130 interacting with the digital assistant 114 in multiple interaction modes respectively may all be stored in association with the user 130. As such, in one of the plurality of interaction modes (either or a specified one of the interaction modes), the digital assistant 114 may provide services to the user 130 based on historical interaction information stored in association with the user 130.

The digital assistant 114 may be called or waken in an appropriate manner (e.g., shortcut, button, or voice) to present an interactive window with the user 130. The interactive window with the digital assistant 114 may be started by selecting the digital assistant 114. The interactive window may include interface elements for information interaction, such as an input box, a message list, a message bubble, and so on. In other embodiments, the digital assistant 114 may be waken through an entry control or a menu provided in the interface 140, or may be called by entering a preset instruction.

The interactive window of the digital assistant 114 with the user 130 may include a conversation window, such as a conversation window in an instant messaging module of an instant messaging application or a specific application. In the conversation window, the interaction between the digital assistant 114 and the user 130 may be presented in the form of a session message. Alternatively, or additionally, the interactive window between the digital assistant 114 and the user 130 may also include other types of windows, such as a window of floating window mode, where the user 130 may trigger the digital assistant 114 to perform a corresponding operation by inputting an instruction, selecting a shortcut instruction, or the like.

In some embodiments, the digital assistant 114 may support an interactive mode of a conversation window, also referred to as a conversation mode. In the interactive mode, a conversation window between the user 130 and the digital assistant 114 is presented, and in the conversation window, the user 130 interacts with the digital assistant 114 through a conversation message. In the conversation mode, the digital assistant 114 may perform a task according to the conversation messages in the conversation window. In the interactive window, the user 130 enters an interactive message, and the digital assistant 114 provides a reply message in response to the user input. By selecting the digital assistant 114, a conversation window with the digital assistant 114 may be started. The conversation window may include interface elements for information interaction, such as an input box, a message list, a message bubble, and so on.

In some embodiments, the terminal device 110 communicates with the server-end device 120 to enable provision of the services to the digital assistant 120 and the service component 125. The terminal device 110 may be any type of mobile terminal, fixed terminal, or portable terminal including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a game device, or any combination of the foregoing, including accessories and peripherals for these devices, or any combination thereof. In some embodiments, the client device 110 can also support any type of interface for a user (such as “wearable” circuitry, etc.). The server-end device 130 may be various types of computing systems/servers capable of providing computing capabilities, including, but not limited to, mainframes, edge computing nodes, computing devices in a cloud environment, etc.

It should be understood that the structure and function of the various elements in environment 100 are described for example purposes only, and are not intended to imply any limitation on the scope of the disclosure.

Conventionally, if a user wants to view a notification, the user may provide, according to a type of the notification that he/she wants to view, a notification viewing entry for triggering a notification corresponding to the type to view the notification. For example, if a user desires to view notifications generated by other users who follows him/her, the user can trigger a follow list viewing entry to view notifications generated by other users who follows him/her. In this case, if the user desires to view various types of notifications, the user needs to perform a plurality of operations, which results in poor efficiency of the user in viewing the notifications.

In addition, conventionally, if a user wants to view a plurality of notifications of a target type, the plurality of notifications would be provided to the user, and it would be difficult for the user to find notifications from the plurality of notifications that he/she should pay more attention to. This can impact the efficiency with which the user views the notification and obtains useful information.

In addition, conventionally, the electronic device can provide the acquired notification directly to the user only in response to the acquisition of the notification. Although this may ensure that the user acquires the notification in real time, providing the notification to the user multiple times in a short time period may affect the user experience.

In view of the above, according to an embodiment of the present disclosure, there is provided an improved solution for message notification. According to the solution of the embodiment of the present disclosure, at least one notification for a first user is acquired. The at least one notification is generated respectively in response to: interactive behaviors associated with the first user and performed by at least one second user. Association information between the first user and the at least one second user is determined; and notification message content for the first user is generated based at least on the association information and the at least one notification. The notification message content is provided to the first user.

In this way, the notification message content to be provided to the user for viewing may be dynamically determined in connection with the association information among multiple users and a notification triggered based on the interaction behavior. This helps improve the efficiency with which the user acquires notifications.

Some example embodiments of the present disclosure will be described below with continued reference to the accompanying drawings.

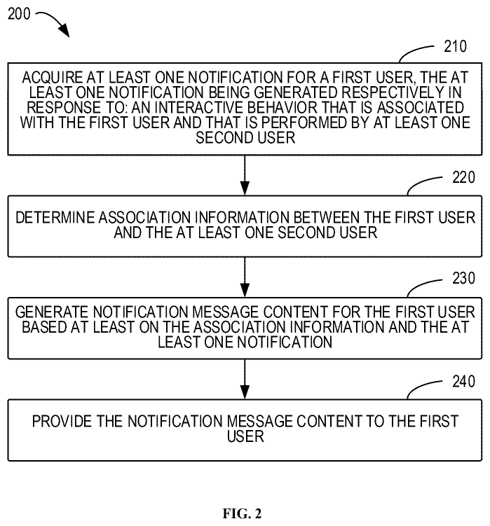

FIG. 2 illustrates a flowchart of a process 200 for message notification according to some embodiments of the disclosure. For ease of discussion, the process 200 will be described with reference to the environment 100 of FIG. 1. The process 200 can be implemented at the client device 110 and/or the server device 120. For ease of description, the process 200 is illustrated as being implemented at the server device 120.

It should be noted that, if the process 200 being implemented at the client device 110 is taken as an example, some operations described with reference to the client device 110 may be completed with the assistance of the server device 120. It should be noted that the operations executed by the client device 110 may specifically be executed by a related application and/or a digital assistant installed on the client device 110.

At block 210, the server device 120 acquires at least one notification for a first user, the at least one notification is generated respectively in response to interactive behaviors associated with the first user and performed by at least one second user.

In this document, for ease of discussion, a user who is to be provided with a notification is referred to as a “first user”, and a user who performs an interactive behavior to trigger the notification is referred to as a “second user”. Note that “first” and “second” herein do not imply any order or other aspect.

Each of the at least one notification may be generated in response to an interactive behavior associated with the first user and performed by a certain second user. The interactive behavior may include, for example, an interactive behavior performed by the second user on the first user, which may include, but is not limited to, following, unfollowing, private chatting, special following, and the like performed on the first user. The interactive behaviors, for example, may further include an interactive behavior performed by the second user on content published by the first user, where the content published by the first user may be, for example, a post, multimedia content (including but not limited to an image, text, image and text, a video, an audio, and the like), and a comment. The interactive behaviors performed on the content published by the first user may include, but are not limited to, a liking behavior, a collecting behavior, a retweeting behavior, a commenting behavior, and so on.

In some embodiments, alternatively or additionally, the interactive behavior may further include, for example, an interactive behavior performed on a digital assistant published by the first user, which may include, for example but not limited to, collecting, liking, using a digital assistant, commenting on a digital assistant, etc. For example, interactive areas (for example, a forum, etc.) of various types of digital assistants that have been published may be provided on a publishing platform or a creating platform for a digital assistant, and in the interactive area, a user may publish a post for a specific digital assistant for discussion, comment on the post, and performing a liking or collecting behavior on the digital assistant. In such a case, the creator or administrator of the digital assistant may act as the recipient of the notification.

The type of the interactive behavior capable of triggering the notification may depend on a specific application setting, and the embodiment of the present disclosure does not specifically limit this aspect.

As an example, the server device 120 may acquire, in response to detecting that a certain second user performed a following behavior on the first user, a notification generated by this following behavior, and the notification may inform the first user that a second user followed the first user. The server device 120 may acquire, in response to detecting that a certain second user performed a liking behavior on multimedia content published by the first user, a notification generated by the liking behavior, and the notification may inform the first user that a second user has performed a liking behavior on the multimedia content published by the first user.

The server device 120 may, for example, cache the acquired at least one notification. Alternatively, or additionally, in some embodiments, the server device 120 may also delete the cached at least one notification periodically or in response to a predetermined rule. For example, the server device 120 may delete the cached at least one notification in response to the first user having viewed the at least one notification. For another example, the server device 120 may delete the cached at least one notification in response to a duration of the at least one notification being cached reaching a predetermined duration (for example, any duration such as one month or three months).

At block 220, the server device 120 determines association information between the first user and the at least one second user.

In some embodiments, the association information may include historical interactive information between the first user and the at least one second user. For each second user, the historical interactive information between the second user and the first user may indicate whether a historical interactive behavior have been performed between the second user and the first user. For example, the historical interactive information may indicate whether a commenting behavior, a liking behavior, a private chatting behavior, etc. occurred between the second user and the first user. Alternatively, or additionally, in some embodiments, the association information may also include a social relationship between the first user and the at least one second user. For each second user, the social relationship between the second user and the first user may, for example, indicate a following relationship between the two (for example, the first user followed the second user, and/or the second user followed the first user), a friend relationship (for example, whether the two users are friends, whether the two users are close friends, or the like).

In some embodiments, the association information among a plurality of users may be stored in a user database. This user database may be a database for a plurality of users. The server device 120 may obtain the association information between the at least one second user and the first user from the user database based on the identifier of each of the at least one second user and the identifier of the first user. Each user's identifier may include, for example, the user's name, ID, number, avatar, tag, etc. Alternatively, or additionally, this user database may also be a database for the first user, in which case different users may correspond to different user databases. The server device 120 may, for example, determine a first database corresponding to the first user from a plurality of user databases based on an identifier of the first user, and then acquire an association relationship between the at least one second user and the first user from the first database based on respective identifiers of the at least one second user. It can be understood that the information in the user database can be updated in response to changes in the association information among the users.

In some embodiments, the association information can indicate a degree of association between the second user and the first user. In an interactive scenario, a degree of association between users is generally determined by historical interactive data between the users and/or a social relationship between the users. For example, if historical interactive information between a certain second user and the first user is richer (for example, a plurality of interactive behaviors occur), the association between the second user and the first user is stronger. If a social relationship between a certain second user and the first user indicates that the two are in a mutually-following relationship, and a social relationship between another second user and the first user indicates that the two are in a one-way-following relationship (i.e., the second user followed the first user or the first user followed the second user), the degree of association between the second user and the first user corresponding to the mutually-following relationship is greater than the degree of association between the second user and the first user corresponding to the one-way-following relationship.

At block 230, the server device 120 generates notification message content for the first user based at least on the association information and the at least one notification. Specifically, the server device 120 may generate the notification message content for the first user based at least on the association relationship and the content and the type of each notification in the at least one notification.

In some embodiments, if at least one notification includes a plurality of notifications, the server device 120 may also cluster the plurality of notifications based on the type of each notification in the plurality of notifications, and then generate the notification message content based on the clustering result.

The type of a notification may, for example, be associated with an interactive behavior corresponding to the notification. For example, if the plurality of notifications include a set of notifications generated by the following behavior, a set of notifications generated by the commenting behavior, and a set of notifications generated by the private chatting behavior, the server device 120 may determine that the plurality of notifications include three types of notifications corresponding to these three behaviors (i.e., the following behavior, the commenting behavior, and the private chatting behavior). For example, for a set of notifications of each type, the server device 110 may generate notification message content corresponding to the set of notifications based on an association relationship between a set of second users corresponding to the set of notifications and the first user as well as the set of notifications. The server device 120 may further generate the notification message content for the first user based on a plurality of pieces of notification message content corresponding to a plurality of groups of notifications of a plurality of types. The generated notification message content can be a summary, an overview, extracted key information, etc., of a plurality of pieces of notification message content to be aggregated. Thus, different types of notifications can be distinguished, and it is convenient for a user to acquire a plurality of types of notifications.

In some embodiments, the server device 120 may also generate notification message content for the first user based on historical interactive information of the first user with regard to the notification of at least one type. In particular, for each type of at least one type of the at least one notification, the server device 120 may determine the historical interactive information of the first user with regard to the type of notification. The historical interactive information may indicate at least a viewing record of the first user with respect to the type of notification. As an example, the historical interactive information may indicate whether the type of notification is viewed by the first user. For the type of notification viewed by the first user, the historical interactive information may, for example, also indicate the time when the first user viewed the type of notification. The server device 120 may further generate the notification message content for the first user based on the historical interactive information corresponding to the notification of the at least one type, the association information, and the at least one notification.

In some embodiments, if the at least one notification includes a plurality of notifications, the server device 120 may also determine respective priorities of the plurality of notifications based at least on the association information and the at least one notification. The server device 120 may determine the priorities in any suitable manner. For example, the server device 120 may determine the priorities based on a predetermined rule or algorithm. For another example, the server device 120 may also determine the priorities by using a machine learning model. As an example, the association information between the second user corresponding to a certain notification and the first user indicates that the closer an association between the second user and the first user is, the higher the priority corresponding to the notification is. The closer the acquisition time corresponding to the notification (i.e., the time when the server device 120 acquires the notification) is to the current time, the higher the priority corresponding to the notification is.

In some embodiments, the server device 120 may also prioritize notifications based on their urgency degrees. The server device 120 may, for example, determine respective urgency degrees of different notifications based on user pre-configuration and/or content in the notifications. It can be understood that, the higher the urgency degree corresponding to a certain notification is, the more urgent the notification needs to be processed by the user. The urgency degree and priority of each notification may be positively correlated. For example, notifications belonging to an error-reporting type or containing error-reporting content may be at a highest urgency degree, and notifications belonging to an error-reporting type or containing error-reporting content may have a higher priority than notifications of other notification types. In some embodiments, the server device 120 may also prioritize notifications based on the type of interaction behavior that triggered the notification. For example, if the interaction behavior are content of posts, content of comments, or the like of a digital assistant or another application published by another user to the first user, the notification is prioritized higher.

In some embodiments, the server device 120 may also determine the priority of the notification based on the interactive behavior corresponding to the notification. For example, a priority of a notification corresponding to a mutual-following behavior>a priority of a notification corresponding to a one-way-following behavior>a priority of a notification corresponding to a liking behavior>a priority of a notification corresponding to a commenting behavior, and the like. In some embodiments, the server device 120 may also determine a priority of a notification based on the interactive content associated with the interactive behavior corresponding to the notification. Taking the case that the interactive behavior is a commenting behavior as an example, the notification in which the corresponding comment content is positive content (for example, content representing rewards, likes and interests) has a higher priority than the notification in which the corresponding comment content is negative content.

The server device 120 may further generate the notification message content for the first user based on respective priorities of the plurality of notifications. In some embodiments, the higher the priority of a notification is, the higher priority the notification may be provided to the first user in the generated notification message content, and/or the more complete the description of the notification in the notification message content is. For example, if the first set of notifications includes 100 notifications, the server device 110 may completely provide, in the generated notification message content, only three notifications with the highest corresponding priorities, and the three notifications may be presented in front of content corresponding to other notifications. The server device 120 may briefly describe other notifications with a lower priority in the generated notification message content, so as to ensure the simplicity of the notification message content finally provided to the first user.

It may be understood that if a plurality of notifications include a plurality of groups of notifications corresponding to the plurality of types, the server device 120 may also determine, for a set of notifications corresponding to each type, a priority of each notification in the set of notifications, and then generate notification message content corresponding to the set of notifications based on the priorities. For example, the server device 120 may also determine respective priorities of a plurality of types, and generate the notification message content for the first user based on respective priorities of the plurality of types and a plurality of pieces of notification message contents corresponding to the plurality of types.

In some embodiments, the server device 120 may generate prompt input (prompt) for a target machine learning model based at least on the association information and the at least one notification. This target machine learning model may be based on any suitable model structure including, but not limited to, a Transformer model, a convolutional neural network (CNN), a recurrent neural network (RNN), a deep neural network (DNN), etc. In some embodiments, the target machine learning model may be based on a language model (LM). The language model can be provided with question-and-answer capabilities by learning from a large amount of corpus. The target machine learning model may also be based on other suitable models. The target machine learning model may, for example, summarize, sort (e.g., sort notifications based on priorities), etc., at least one notification based on the prompt input to determine model output corresponding to the prompt input.

The server device 120 may provide the prompt input to the target machine learning model to acquire model output corresponding to the prompt input from the target machine learning model. The server device 120 may then determine the notification message content for the first user based on the model output of the target machine learning model. For example, the model output may include text of the notification message content. The server device 120 may predetermine a manner of providing the notification message content. For example, the server device 120 may provide the notification message content to the first user in the form of a card. The server device 120 may obtain the notification message content by rendering the text of the notification message content on the card, and then provide the notification message content in the form of the card to the first user. For example, if the at least one notification includes a plurality of notifications, and the plurality of notifications are a plurality of types of notifications, the server device 120 may also determine text corresponding to each type of notifications based on the model output (it can be understood that text corresponding to the plurality of types of notifications together constitutes the notification message content), and then a notification list is generated. Each row of the notification list may, for example, present text corresponding to a type of notification, such as the list may be the notification message content that may ultimately be provided to the first user.

In some embodiments, if the at least one notification includes a plurality of notifications, the server device 120 may further determine to present, in the notification message content, notifications corresponding to different priorities in different ways, based on respective priorities of the plurality of notifications determined above. For example, the server device 120 may present a notification with a higher corresponding priority in a significant manner such as bold, highlight, enlarging the font, slanting, underlining the notification message content, and present the notification with a lower corresponding priority in a form of common text.

At block 240, the server device 120 provides the notification message content to the first user. The server device 120 may provide the notification message content to the first user in any suitable form. For example, the server device 120 may provide a notification message of any proper type (such as a text type, a card type, and a list type) to the user in a manner of a pop-up window or a short message, and specific content of the notification message is the notification message content determined in the foregoing manner. The present disclosure does not limit a specific manner of providing the notification message content.

A specific manner of message notification is described below with reference to some example scenarios of message notification.

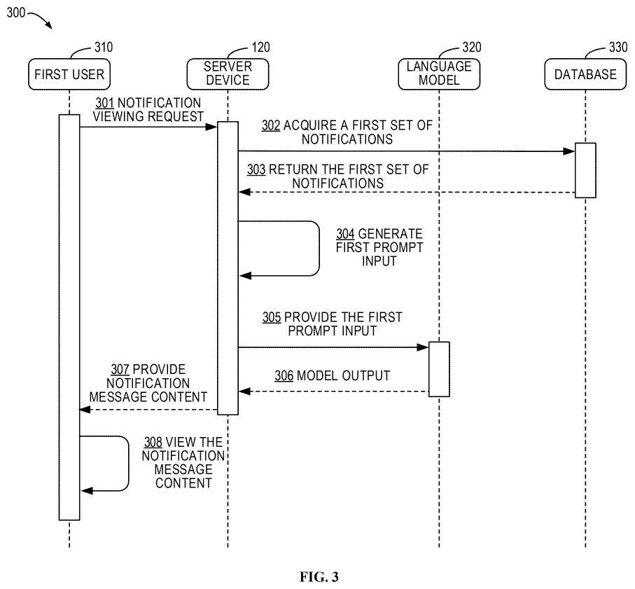

In some example scenarios, the server device 120 may acquire, in response to detecting a notification viewing request from a first user, a first set of notifications for the first user, and generate notification message content for the first user based on the first set of notifications. The notification viewing request may indicate provision to the first user with notifications that he/she does not view. FIG. 3 shows a schematic view of a signaling flow 300 for message notification according to some embodiments of the present disclosure. For ease of discussion, the signaling flow 300 is described with reference to FIG. 1. As shown in FIG. 3, the signaling flow 300 involves a first user 310, a server device 120, a language model 320, and a database 330. Note that, for ease of explanation, the signaling flow is shown in FIG. 3 and FIGS. 4 and 5 which will now be described, from the viewpoint of the user, but the operation described with respect to the user is actually performed by the client device to which the user corresponds. For distinction, a client device corresponding to the first user is referred to as a first client device, and a client device corresponding to the second user is referred to as a second client device, and so on.

The first client device corresponding to the first user 310, for example, may provide a notification viewing control, for example, by clicking a notification entry/an intra-station communication entry. The first client device may determine that a notification viewing request is received from the first user 310 in response to receiving a trigger operation (e.g., a click operation, a hover operation, a double-click operation, a long-press operation, etc.) of the first user 310 on the notification viewing control. The first client device may provide a notification viewing request to the server device 120 through a communication connection with the server device 120, so that the server device 120 detects (301) the notification viewing request from the first user 310.

The server device 120 may further acquire a first set of notifications from the database 330 in response to the notification viewing request, where the first set of notifications includes a notification that is not viewed by the first user 310, such as, a notification cached for the first user from the time that the user viewed the notification last time and the time that the user viewed the notification this time. The database 330 may store a plurality of notifications associated with the first user 310. Specifically, the server device 120 may send (302) to the database 330 a request for acquiring the first set of notifications. The database 330, in turn, can return (303) to the server device 120, in response to this request, a first set of notifications obtained from the time that the user viewed the notification last time and the time that the user viewed the notification this time.

The server device 120 may generate (304) first prompt input for a target machine learning model (for example, the language model 320) according to an association relationship between each second user corresponding to the first set of notifications and the first user 310, the first set of notifications itself, a types corresponding to the first set of notifications, historical interactive information of the first user 310 with respect respective types of notifications corresponding to the first set of notifications, and the like. The server device 120 may provide (305) the first prompt input to the language model 320. The language model 320 may generate corresponding model output based on the received first prompt input, and return (306) the model output to the server device 120.

The server device 120 may, in turn, determine the notification message content based on the received model output. The determination of the notification message content may, for example, refer to the description above and is not repeated here. The server device 120 may provide (307) the notification message content to the first user 310 for the first user 310 to view (308) the notification message content.

Thus, in response to the notification viewing request from the first user, the server device 120 may generate the notification message content for the first user based on a first set of notifications that are not viewed by the first user. This can help the first user quickly view the content that is not viewed by the first user, and can improve the efficiency of viewing the notification by the first user.

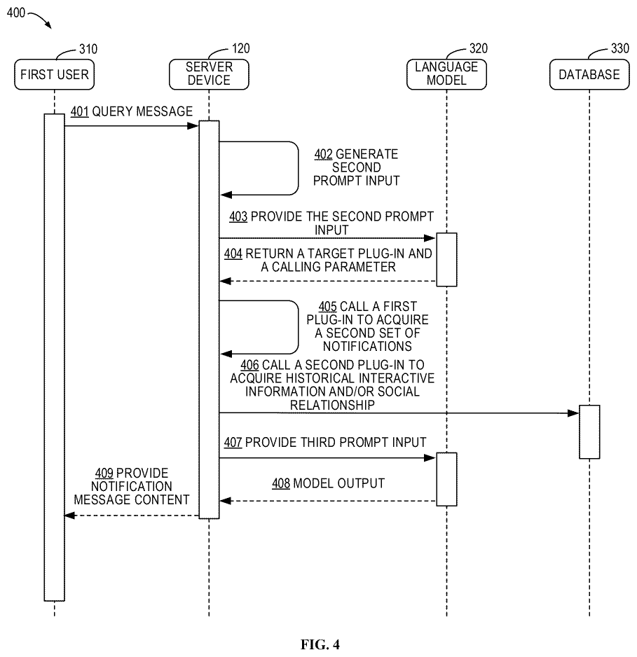

In some example scenarios, a particular digital assistant can be configured to support a messaging service. Configuration information for the digital assistant can provide functions for message query and message content generation. In this case, the query message from the first user for the digital assistant may be received in the interaction between the first user and the digital assistant. The server device 120 (which may be understood as a server device corresponding to the digital assistant) may obtain the second set of notifications based on the query message, and generate the notification message content for the first user based on the second set of notifications. The query message may indicate provision to the first user a particular type of notification and/or a notification corresponding to the particular time period. FIG. 4 illustrates a schematic diagram of a signaling flow 400 for message notification according to further embodiments of the present disclosure. For ease of discussion, the signaling flow 400 is described with reference to FIG. 1. As shown in FIG. 4, the signaling flow 400 involves a first user 310, a server device 120, a language model 320, and a database 330.

The first client device corresponding to the first user 310 may, for example, provide an interactive interface between the first user 310 and the digital assistant, and the interactive interface may be, for example, a conversation interface. The first client device can receive the user input of the first user 310 via this interactive interface. The first client device can present, in this interactive interface, the user input of the first user 310 in the form of a conversation message from the user, and present a reply by the digital assistant to the conversation message of the first user 310 in the form of a conversation message from the digital assistant. The first client device may determine to acquire the query message in response to the user input indicating that a notification is to be acquired.

The first client device may provide a query message to the server device 120 through a communication connection with the server device 120, so that the server device 120 receives (401) the query message from the first user 310. The server device 120 may determine, based on the query message, a notification type of the notification to be queried and/or a time period corresponding to the notification to be queried. Taking the query message being “who followed me within a month” as an example, the server device 120 may determine, based on the query message, that the notification type is a notification corresponding to the following behavior, and the corresponding time period is one month. In interaction with the digital assistant, the user-initiated query message may be initiated by using text and/or speech in a natural language, etc. Thus, the query message from the user may be determined by processing the query message received from the user.

The server device 120 may acquire a second set of notifications from the notifications associated with the first user 310 based on the determined results (i.e., the determined notification type and/or time period). In some embodiments, the server device 120 may, by using the plug-in, obtain a second set of notifications from the notifications associated with first user 310 based on the determined results. As an example, the server device 120 may generate (402) second prompt input based on all plug-ins associated with the digital assistant, where the second prompt input may instruct a target machine learning model (for example, the language model 320) to determine, from all the plug-ins, at least one plug-in for acquiring a notification and acquiring historical interactive information and/or a social relationship between the second user corresponding to the notification and the first user 310.

The server device 120 may provide the second prompt input to the language model 320. The language model 320 may determine, based on the second prompt input, a target plug-in (which may include at least one plug-in) to be called by the server device 120 and a calling parameter for calling the target plug-in. The language model 320 may then return (403) the target plug-in and calling parameter to the server device 120. The target plug-in may include a first plug-in configured to acquire a notification of the first user 310 corresponding to the notification type and/or time period and a second plug-in configured to determine historical interactive information and/or social relationship between a plurality of users (that is, the second plug-in is configured to acquire association information between a plurality of users). The calling parameter for the first plug-in may include, for example, a determined notification type and/or a determined time period, and the calling parameter for the second plug-in may include, for example, user identifiers of a set of second users corresponding to the second set of notifications and the first user 310. As mentioned previously, the user identifier may include a username, ID, label, avatar, and so forth.

The server device 120 may use the determined notification type and/or the determined time period to call (405) the first plug-in associated with the digital assistant, and acquire a second set of notifications returned by the first plug-in. The server device 120 may further use a set of second users (which may also be referred to as a second set of second users) corresponding to the second set of notifications and the user identifier of the first user 310 to call (406) the second plug-in associated with the digital assistant, so as to acquire the historical interactive information and/or the social relationship returned by the second plug-in. The server device 120 may further determine, based on the historical interactive information and/or the social relationship returned by the second plug-in, the association information between the first user 310 and the set of second users.

The server device 120, for example, may generate third prompt input for a target machine learning model (for example, the language model 320) according to association relationship between a second set of second users corresponding to the second set of notifications and the first user 310, the second set of notifications, historical interactive information of the second set of types of notifications corresponding to the second set of notifications from the first user 310, and the like. The server device 120 may provide the third prompt input (407) to the language model 320. The language model 320 may generate corresponding model output based on the received third prompt input, and return (408) the model output to the server device 120. The server device 120 may, in turn, determine the notification message content based on the received model output. The determination of the notification message content may, for example, refer to the description above and is not repeated here. The server device 120 may provide (409) the notification message content to the first user 310 for the first user 310 to view the notification message content.

In some embodiments, in the interaction of the first user 310 with the digital assistant, the server device 120 may provide the first user 310 with the notification message content as a reply to the query message. Specifically, the server device 120 may provide the notification message content to the first client device. The first client device may present, in an interaction interface between the first user 310 and the digital assistant, the notification message content to the first user 310 in the form of a conversation message.

Thus, in interaction between the first user and the digital assistant, the server device 120 may acquire a set of notifications matching the query message, in response to detecting a query message indicating provision of notification to the first user, and generate notification message content based on the set of notifications. The notification message content may be provided to the first user in the form of a reply to the query message, which may improve the efficiency of the first user in viewing the notification and enrich interaction of the first user with the digital assistant.

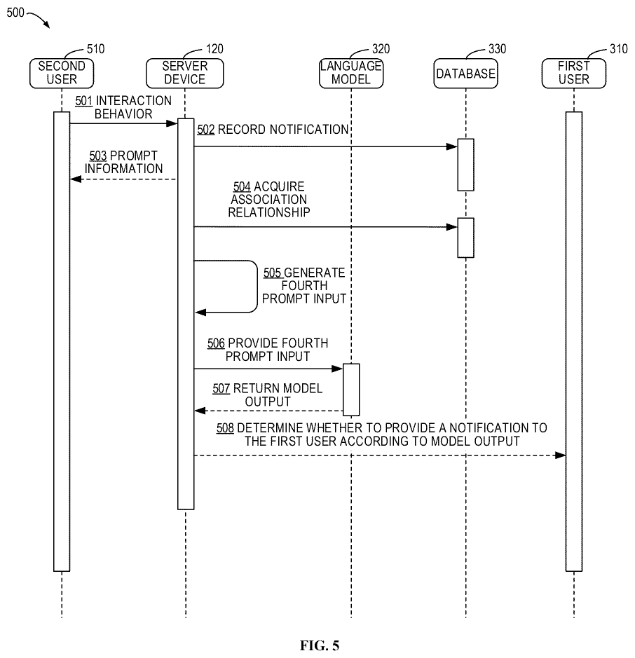

In some example scenarios, the server device 120 may also determine at least one notification to the first user in response to detecting at least one interaction behavior of a target second user in the at least one second user with the first user. FIG. 5 shows a schematic diagram of a signaling flow 500 for message notification according to yet other embodiments of the present disclosure. For ease of discussion, the signaling flow 500 is described with reference to FIG. 1. As shown in FIG. 5, the signaling flow 500 involves a first user 310, a server device 120, a language model 320, a database 330, and a second user 510.

The server device 120 may determine at least one notification for the first user 310 in response to detecting (501) at least one interaction behavior of a target second user (e.g., the second user 510) with the first user 310. For example, if the server device 120 detects a following behavior by the second user 510 on the first user 310, the server device 120 may determine a notification corresponding to the following behavior. The server device 120 may record the determined notification (502) in the database 330. In some embodiments, the server device 120 may further provide (503) prompt information to the second user 510 to inform the second user of the result of the interaction behavior. For example, the server device 120 may further provide prompt information to the second user 510 to inform the second user that the following behavior is performed successfully.

The server device 120 may also determine whether at least one notification is to be pushed to the first user based on the association relationship between the second user 510 and the first user 310 and the at least one notification. As an example, the server device 120 may acquire (504) the association relationship between the second user 510 and the first user 310 from the database 330. The server device 120 may generate (505) fourth prompt input for a target machine learning model (e.g., the language model 320) based on the acquired association relationship and the at least one notification.

In some embodiments, in addition to considering an association relationship between users, the server device 120 may also determine an urgency degree of the at least one notification, and/or a type of interaction behavior that triggered the at least one notification. In some embodiments, the server device 120 may generate the fourth prompt input based on the association relationship, the notification content of the at least one notification, and an urgency degree of the at least one notification and/or type of the interaction behavior. For example, if the notification is an error-reporting type notification including error-reporting content, the server device 120 may utilize the language model 320 to determine, based on fourth prompt input, that the notification is likely to require the first user to process the notification in a timely manner. For another example, if the interaction behaviors that triggered the notification are content of posts, content of comments, or the like of a digital assistant or another application published by another user to the first user, the server device 120 may determine, by using the language model 320 and based on the fourth prompt input, whether such a notification needs to be pushed to the user in time.

In some embodiments, the server device 120 may further generate fourth prompt input based on a speed at which a historical notification corresponding to the notification type of each notification in the at least one notification is viewed by the first user, a viewing ratio, or the like. For example, if a set of historical notifications having the same or similar notification type or content as the at least one notification are viewed by the first user in time each time, the server device 120 may determine that the first user has a faster speed in viewing the set of historical notifications, and further determine that the first user may be expected to acquire notifications of the same type in time. The server device 120 may utilize the language model 320 to determine, based on the generated fourth prompt input, that at least one notification of that type may need to be provided to the first user instantaneously. For another example, if after a set of historical notifications are provided to the first user, the first user did not read the notifications after a long time period or directly ignored the notifications, the server device 120 may determine that it may not be necessary to push notifications of this type or notifications with similar content to the first user in time subsequently.

It can be understood that the server device 120 may also generate or adjust fourth prompt input based on another predetermined policy, which is not limited in the present disclosure. In some embodiments, the policy for timely pushing notifications may be user configurable. For example, the first user may specify the type of notifications expected to be pushed in a timely manner, the content of the notifications, the user who triggered the notification, and so forth. In this case, it may be determined whether the currently received notification is to be provided to the first user in a timely manner based on a policy configured by the user. In some embodiments, a user-configured policy may be included in the fourth prompt input of the language model 320, so that the language model 320 determines the notification message content to be provided to the user.

The fourth prompt input can indicate a determination of whether to provide at least one notification to the first user 310. The server device 120 can provide (506) the fourth prompt input to the language model 320. The language model 320 may generate (507) corresponding model output based on the received first prompt input, and return the model output to the server device 120.

The server device 120 may, in turn, determine whether to provide at least one notification to the first user based on the received model output. If the server device 120 determines to provide at least one notification to the first user 310, the server device 120 may generate the notification message content for the first user based at least on the at least one notification and the association relationship between the second user 510 and the first user 310. For generation of the notification message content, reference may be made to the foregoing description, which is not repeated herein.

Thus, in response to detecting am interaction behavior of the second user, the server device 120 may determine, based on the association relationship between the second user and the first user, whether to automatically provide the notification corresponding to the interaction behavior to the first user. This can improve the efficiency with which the first user acquires notifications.

In conclusion, according to the embodiments of the present disclosure, the notification message content to be provided to the user can be determined in conjunction with the association information among the plurality of users and the notifications, thereby providing the notification message content to the user. This helps improve the efficiency with which the user acquires notifications.

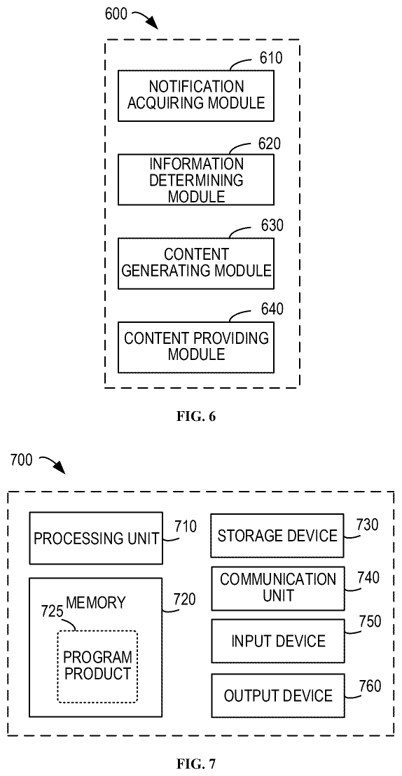

Embodiments of the present disclosure also provide corresponding apparatus for implementing methods or processes described above. FIG. 6 illustrates an example structural block diagram of an apparatus 600 for message notification in accordance with some embodiments of the present disclosure. The apparatus 600 may be implemented as or included in a server device 120. The various modules/components in the apparatus 600 may be implemented by hardware, software, firmware, or any combination thereof.

As illustrated in FIG. 6, the apparatus 600 includes a notification acquiring module 610 configured to acquire at least one notification for a first user, the at least one notification being generated respectively in response to: an interactive behavior associated with the first user and performed by at least one second user. The apparatus 600 further includes an information determining module 620 configured to determine association information between the first user and the at least one second user. The apparatus 600 also includes a content generating module 630 configured to generate notification message content for the first user based at least on the association information and the at least one notification. The apparatus 600 also includes a content providing module 640 configured to provide the notification message content to the first user.

In some embodiments, the association information includes at least one of: historical interactive information between the first user and the at least one second user, or a social relationship between the first user and the at least one second user.

In some embodiments, the content generating module 630 is further configured to: determine, based on at least one type of the at least one notification, historical interactive information of the first user for the at least one type of notification; and generate the notification message content for the first user further based on the historical interactive information of the first user for the at least one type of notification.

In some embodiments, the at least one notification includes a plurality of notifications, and the content generating module 630 is further configured to: determine respective priorities of the plurality of notifications based at least on the association information and the plurality of notifications; and generate the notification message content for the first user based on the respective priorities of the plurality of notifications.

In some embodiments, the content generating module 630 is further configured to determine the respective priorities of the plurality of notifications further based on urgency degrees of the plurality of notifications, wherein the urgency degrees of the plurality of notifications are determined based at least on a user configuration and/or content in the plurality of notifications.

In some embodiments, the content generating module 630 is further configured to: generate prompt input for a target machine learning model based at least on the association information and the at least one notification; provide the prompt input to the target machine learning model; and determine the notification message content for the first user based on model output of the target machine learning model.

In some embodiments, the notification acquiring module 610 is further configured to acquire, in response to detecting a notification viewing request from the first user, a first set of notifications for the first user, the first set of notifications including a notification unviewed by the first user.

In some embodiments, the notification acquiring module 610 is further configured to receive, in an interaction between the first user and a digital assistant, a query message from the first user for the digital assistant; determine, based on the query message, a notification type to be queried and/or a time period corresponding to a notification to be queried; and acquire, based on a result of the determination, a second set of notifications from notifications associated with the first user.

In some embodiments, the notification acquiring module 610 is further configured to call a first plug-in associated with the digital assistant with the determined notification type and/or the determined time period, the first plug-in being configured to acquire a notification of the first user corresponding to the notification type and/or the time period; and acquire the second set of notifications returned by the first plug-in.

In some embodiments, the information determining module 620 is further configured to call a second plug-in associated with the digital assistant with a set of second users corresponding to the second set of notifications and a user identifier of the first user, the second plug-in being configured to determine association information among a plurality of users; and determine association information between the first user and the set of second users based on the historical interactive information and/or social relationship returned by the second plug-in.

In some embodiments, the content providing module 640 is further configured to provide, the interaction between the first user and the digital assistant, the notification message content to the first user as a reply to the query message.

In some embodiments, the notification acquiring module 610 is further configured to in response to detecting at least one interaction behavior of a target second user in the at least one second user with the first user, determine the at least one notification for the first user; and the content generating module 630 is further configured to determine whether the at least one notification is to be pushed to the first user based on at least one of the association information, the content in the at least one notification, an urgency degree of the at least one notification, or a type of the at least one interaction behavior; and in response to determining that the at least one notification is to be pushed to the first user, generate the notification message content that includes the at least one notification.

In some embodiments, the interactives behavior corresponding to the at least one notification includes at least one of an interactive behavior performed on the first user, an interactive behavior performed on content published by the first user, or an interactive behavior performed on a digital assistant published by the first user.

The units and/or modules included in apparatus 600 may be implemented in a variety of ways, including software, hardware, firmware, or any combination thereof. In some embodiments, one or more units and/or modules may be implemented using software and/or firmware, such as machine-executable instructions stored on a storage medium. In addition to or as an alternative to machine executable instructions, some or all of the units and/or modules in apparatus 600 may be implemented, at least in part, by one or more hardware logic components. By way of example, and not limitation, illustrative types of hardware logic components that can be used include Field-programmable Gate Arrays (FPGAs), Program-specific Integrated Circuits (ASICs), Application-Specific Standard Products (ASSPs), System-on-a-chip systems (SOCs), Complex Programmable Logic Devices (CPLDs), etc.

It should be understood that one or more steps of the above methods may be performed by a suitable electronic device or combination of electronic devices. Such an electronic device or a combination of electronic devices may include, for example, the server device 120 in FIG. 1.

FIG. 7 illustrates a block diagram of an electronic device 700 in which one or more embodiments of the present disclosure may be implemented. It should be appreciated that the electronic device 700 shown in FIG. 7 is merely illustrative and should not constitute any limitation on the functionality and scope of the embodiments described herein. The electronic device 700 shown in FIG. 7 may be configured to implement the server device 120 shown in FIG. 1 or the apparatus 600 shown in FIG. 6.

As shown in FIG. 7, the electronic device 700 is in the form of a general-purpose electronic device. Components of the electronic device 700 may include, but are not limited to, one or more processors or processing units 710, a memory 720, a storage device 730, one or more communications units 740, one or more input devices 750, and one or more output devices 760. The processing unit 710 may be an actual or virtual processor and can perform various processes according to programs stored in the memory 720. In a multiprocessor system, a plurality of processing units execute computer executable instructions in parallel, so as to improve the parallel processing capability of the electronic device 700.

The electronic device 700 typically includes a number of computer storage media. Such media may be any available media that are accessible by electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that can be used to store information and/or data and that can be accessed within the electronic device 700.

The electronic device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. In addition, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices such as a mouse, keyboard, trackball, etc. The output device 760 may be one or more output devices such as a display, speaker, printer, etc. The electronic device 700 may also communicate with one or more external devices (not shown) such as a storage device, a display device, or the like through the communication unit 740 as required, and communicate with one or more devices that enable a user to interact with the electronic device 700, or communicate with any device (e.g., a network card, a modem, or the like) that enables the electronic device 700 to communicate with one or more other electronic devices. Such communication may be performed via an input/output (I/O) interface (not shown).

According to an example implementation of the present disclosure, a computer readable storage medium is provided, on which a computer-executable instruction is stored, wherein the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some updated implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for message notification, comprising:
acquiring at least one notification for a first user, the at least one notification being generated respectively in response to an interactive behavior that is associated with the first user and that is performed by at least one second user;
determining association information between the first user and the at least one second user;
generating notification message content for the first user based at least on the association information and the at least one notification; and
providing the notification message content to the first user.

2. The method of claim 1, wherein the association information comprises at least one of:
historical interactive information between the first user and the at least one second user; or
a social relationship between the first user and the at least one second user.

3. The method of claim 1, wherein generating the notification message content for the first user comprises:
determining, based on at least one type of the at least one notification, historical interactive information of the first user for a notification of the at least one type; and
generating the notification message content for the first user based on the historical interactive information of the first user for the notification of the at least one type.

4. The method of claim 1, wherein the at least one notification comprises a plurality of notifications, and wherein generating the notification message content for the first user comprises:
determining respective priorities of the plurality of notifications based at least on the association information and the plurality of notifications; and
generating the notification message content for the first user based on the respective priorities of the plurality of notifications.

5. The method of claim 4, wherein determining the respective priorities of the plurality of notifications comprises:
determining the respective priorities of the plurality of notifications further based on urgency degrees of the plurality of notifications, wherein the urgency degrees of the plurality of notifications are determined based on at least one of a user configuration or content in the plurality of notifications.

6. The method of claim 1, wherein generating the notification message content for the first user comprises:
generating a prompt input for a target machine learning model based at least on the association information and the at least one notification;
providing the prompt input to the target machine learning model; and
determining the notification message content for the first user based on a model output of the target machine learning model.

7. The method of claim 1, wherein acquiring the at least one notification for the first user comprises:
in response to detecting a notification viewing request from the first user, acquiring a first set of notifications for the first user, the first set of notifications comprising a notification unviewed by the first user.

8. The method of claim 1, wherein acquiring the at least one notification for the first user comprises:
receiving, in an interaction between the first user and a digital assistant, a query message from the first user to the digital assistant;
determining, based on the query message, at least one of a notification type to be queried or a time period corresponding to a notification to be queried; and
acquiring a second set of notifications from notifications associated with the first user based on the at least one of the notification type or the time period.

9. The method of claim 8, wherein acquiring the second set of notifications from the notifications associated with the first user comprises:
calling a first plug-in associated with the digital assistant with the at least one of the notification type or the time period, the first plug-in being configured to acquire a notification of the first user corresponding to the at least one of the notification type or the time period; and
acquiring the second set of notifications returned by the first plug-in.

10. The method of claim 8, wherein determining the association information between the first user and the at least one second user comprises:
calling a second plug-in associated with the digital assistant with a set of second users corresponding to the second set of notifications and a user identifier of the first user, the second plug-in being configured to determine association information among a plurality of users; and
obtaining the association information returned by the second plug-in.

11. The method according to claim 8, wherein providing the notification message content to the first user comprises:
in the interaction between the first user and the digital assistant, providing the notification message content to the first user as a reply to the query message.

12. The method of claim 1, wherein acquiring the at least one notification for the first user comprises:
in response to detecting at least one interaction behavior of a target second user in the at least one second user with the first user, determining the at least one notification for the first user; and
wherein generating the notification message content for the first user comprises:
determining whether the at least one notification is to be pushed to the first user based on at least one of: the association information, content in the at least one notification, an urgency degree of the at least one notification, or a type of the at least one interaction behavior; and
in response to determining that the at least one notification is to be pushed to the first user, generating the notification message content that comprises the at least one notification.

13. The method according to claim 1, wherein the interactive behavior corresponding to the at least one notification comprises at least one of:
an interactive behavior performed on the first user,
an interactive behavior performed on a content item published by the first user, or
an interactive behavior performed on a digital assistant published by the first user.

14. An electronic device, comprising:
at least one processor; and
at least one memory coupled to the at least one processor and storing instructions executable by the at least one processor, the instructions, when executed by the at least one processor, cause the electronic device to perform operations comprising:
acquiring at least one notification for a first user, the at least one notification being generated respectively in response to an interactive behavior that is associated with the first user and that is performed by at least one second user;
determining association information between the first user and the at least one second user;
generating notification message content for the first user based at least on the association information and the at least one notification; and
providing the notification message content to the first user.

15. The electronic device of claim 14, wherein the association information comprises at least one of:
historical interactive information between the first user and the at least one second user; or
a social relationship between the first user and the at least one second user.

16. The electronic device of claim 14, wherein generating the notification message content for the first user comprises:
determining, based on at least one type of the at least one notification, historical interactive information of the first user for a notification of the at least one type; and
generating the notification message content for the first user based on the historical interactive information of the first user for the notification of the at least one type.

17. The electronic device of claim 14, wherein the at least one notification comprises a plurality of notifications, and wherein generating the notification message content for the first user comprises:
determining respective priorities of the plurality of notifications based at least on the association information and the plurality of notifications; and
generating the notification message content for the first user based on the respective priorities of the plurality of notifications.

18. The electronic device of claim 17, wherein determining the respective priorities of the plurality of notifications comprises:
determining the respective priorities of the plurality of notifications further based on urgency degrees of the plurality of notifications, wherein the urgency degrees of the plurality of notifications are determined based on at least one of a user configuration or content in the plurality of notifications.

19. The electronic device of claim 14, wherein generating the notification message content for the first user comprises:
generating a prompt input for a target machine learning model based at least on the association information and the at least one notification;
providing the prompt input to the target machine learning model; and
determining the notification message content for the first user based on a model output of the target machine learning model.

20. A non-transitory computer readable storage medium having a computer program stored thereon, wherein the computer program is executable by at least one processor to perform operations comprising:
acquiring at least one notification for a first user, the at least one notification being generated respectively in response to an interactive behavior that is associated with the first user and that is performed by at least one second user;
determining association information between the first user and the at least one second user;
generating notification message content for the first user based at least on the association information and the at least one notification; and
providing the notification message content to the first user.
